(19) United States
(12) Patent Application Publication
(10) Pub. No.: US 2025/0161725 A1
(43) Pub. Date: May 22, 2025

(54) PERSONAL COOLING APPARATUS FOR A FALL PREVENTION SAFETY HARNESS

(71) Applicants: John J. CARROCIA, Orchard Park, NY (US); Jeffrey MURRAY, Hamburg, NY (US)

(72) Inventors: John J. CARROCIA, Orchard Park, NY (US); Jeffrey MURRAY, Hamburg, NY (US)

(21) Appl. No.: 18/516,163

(22) Filed: Nov. 21, 2023

(51) Int. Cl. A62B 35/00

(52) U.S. Cl. CPC A62B 35/0025

(57) ABSTRACT

A personal cooling apparatus for use in association with a fall prevention safety harness having at least a shoulder strap portion, a back strap portion, and a waist belt portion, the personal cooling apparatus includes a chest portion and a back portion. Each of the chest portion and the back portion include a cooling portion and a strap receiving portion. The cooling portion includes an inner layer, an outer layer, and a cooling medium disposed between the inner layer and the outer layer. The strap receiving portion of the personal cooling apparatus is securable to at least one of the shoulder strap portion and the back strap portion of the fall prevention safety harness.

### FIELD

The instant disclosure broadly relates to fall prevention systems and fall prevention safety harnesses that prevent or minimize injury as a result from a fall from a height, and more particularly, to cooling systems that can be used in association with fall prevention safety harnesses in order to prevent or reduce heat related injuries.

### BACKGROUND

According to the Occupational Health and Safety Administration, “[m]illions of U.S. workers are exposed to heat in their workplaces. Although illness from exposure to heat is preventable, every year, thousands become sick from occupational heat exposure, and some cases are fatal.” Illness due to heat exposure can occur indoors in places that range from bakeries and kitchens to iron and steel works, as well in firefighting, for example. In such environments, employees are typically exposed to processes that generate heat. However, in many instances in indoor environments, for example, steps can be taken to cool the ambient air, which can reduce the incidence of heat related illness. Illness from heat exposure can also occur in outdoor environments such as agricultural fields and construction sites-especially in the areas of road and roof construction. Unlike indoor environments, however, in outdoor environments it is far more difficult, if not impossible, to reduce the ambient air temperature. Hence, in some instances, in order to avoid heat exposure illness, employees may work shorter shifts, take more frequent breaks, and/or arrange work schedules so as to avoid working in conditions where heat exposure illness is likely to occur. However, it is not always possible to undertake such procedures.

In the field of construction, for example, and roofing construction in particular, employees typically work outdoors and at significant heights. Accordingly, safety measures and regulations for working at a height require that employers and employees undertake specific safety precautions, such as installing railing systems to prevent falls from a building and/or the wearing of individual safety equipment such as a fall prevention safety harness to prevent or reduce injury in the event of a fall.

In the case of fall prevention safety harnesses, such harnesses typically comprise shoulder and back straps, waist belts, leg straps, as well as heavy D-rings and the like in order to secure a safety rope or lead. Hence, fall prevention safety harnesses are often robust and weighty and/or clunky upon the wearer. Additionally, the various straps must be sufficiently tightened against a wearer's body in order to ensure that the fall prevention safety harness remains in place in the event of a fall. Thus, in the case of a roofer working at a height, for example, in addition to potentially being exposed to significant temperatures on a hot, sunny day atop a hot black roof, the additional requirement to wear a tightly secured, weighty and/or clunky fall prevention safety harness can only serve to increase the possibility of illness related to heat exposure.

In the field of cooling and systems for cooling personnel, cooling vests are known. Such systems typically comprise loose, sleeveless, vest-like jackets having one or more interior pockets that receive a cooling insert therein. Hence, a wearer of such vests can easily insert/remove a cooling insert as may be needed, and it is not uncommon to keep a store of frozen or cooled inserts for use at a jobsite.

While such cooling systems are typically appropriate and sufficient for most construction-type job sites, in cases where employees are required to additionally wear a fall prevention safety harness, such cooling systems are, at times, not appropriate or sufficient. That is, in most cases when an employee wears a cooling vest in association with a fall prevention safety harness, the cooling vest is typically worn underneath the fall prevention safety harness. This raises safety issues, as well as other issues. One safety issue is that when a user wears a cooling vest below their fall prevention safety harness, the fall prevention safety harness may not be sufficiently tightened against a user's body and/or may shift in the event of a fall causing injury. Additionally, as cooling harnesses are typically worn loosely, they also tend to bunch up and can cinch under a tightened safety harness, which can cause discomfort to the wearer. When faced with such discomfort, the wearer is then likely to loosen their safety harness. Also, in cases where a user needs to replace a cooling insert, for example, they must first remove their safety harness in order to access their cooling vest, which can result in delay or inconvenience and/or the user simply avoiding the task of changing their insert or choosing to not wear a cooling vest at all. Finally, wearing both a cooling vest and a safety harness increases the number of layers of clothing worn by the user, as well as the weight bore by the user. Hence, there is a need for a cooling system for an individual that can be incorporated with, or used in association with, a fall prevention safety harness that addresses or reduces the above-described problems.

### SUMMARY

At the outset it should be understood that while the following disclosure, figures, and/or claims, etc. describe subject matter including one or more aspects described as either alone or in combination with one or more other aspects, the subject matter of the instant disclosure is not intended to be so limited. That is, the instant disclosure, figures, and claims are intended to encompass the various aspects described herein, either alone or in one or more combinations with one another. For example, while the instant disclosure may describe and illustrate a first aspect, a second aspect, and a third aspect in a manner such that the first aspect is only specifically described and illustrated relative to the second aspect, or the second aspect is only described and illustrated relative to the third aspect, the instant disclosure and illustrations are not intended to be so limiting and may encompass the first aspect alone, the second aspect alone, the third aspect alone, or one or more combinations of the first, second, and/or third aspects, e.g., the first aspect and the second aspect, the first aspect and the third aspect, the second and third aspect, or the first, second and third aspects.

In one or more aspects, a personal cooling apparatus wearable by an individual and configured for use in association with a fall prevention safety harness including at least a shoulder strap portion, a back strap portion, and a waist belt portion, generally includes a chest portion and a back portion. Each of the chest portion and the back portion include a cooling portion and a strap receiving portion. The cooling portion includes an inner layer, an outer layer, and a cooling medium is disposed between the inner layer and the outer layer. The strap receiving portion of the personal cooling apparatus is securable to at least one of the shoulder strap portion and the back strap portion of the fall prevention safety harness. In some aspects, the strap receiving portion of the personal cooling apparatus does not include a cooling medium. In some aspects, the strap receiving portion includes one or more tabs or flaps that can be secured about and/or to at least a shoulder strap portion or a back strap portion of the fall prevention safety harness. In some aspects the tabs or flaps can be folded and secured upon themselves by one or more of hook and loop, one or more snaps, or one or more buttons, etc. In some aspects the tabs or flaps can be secured to one or more of the shoulder strap portion or the back strap portion by one or more of hook and loop, one or more snaps, or one or more buttons, etc.

In one or more aspects the strap receiving portion of the personal cooling apparatus is detachably securable to at least one of the shoulder strap portion and the back strap portion of the fall prevention safety harness. In some aspects, the strap receiving portion is detachably securable to at least one of the shoulder strap portion and the back strap portion using one or more of hook and loop, one or more snaps, one or more buttons, etc. In some aspects, the strap receiving portion is fixedly secured to at least one of the shoulder strap portion and the back strap portion. In some aspects the strap receiving portion is fixedly secured to at least one of the shoulder strap portion and the back strap portion by stitching.

In some aspects, the chest portion and the back portion of the personal cooling apparatus include at least one pocket that receives the cooling medium therein. In some aspects, the at least one pocket includes an opening that is openable and closable using one or more of a zipper, hook and loop, one or more snaps, or one or more buttons, etc. In some aspects, the opening is formed in the outer layer of the personal cooling apparatus, which allows the at least one pocket to be opened and closed from the outside such that a cooling medium can be inserted and removed from the at least one pocket without a user having to remove the personal cooling apparatus from their person.

In some aspects, the chest portion of the personal cooling apparatus extends from a collar portion to a waist portion. In some aspects, the chest portion includes rightward and leftward sides that are detachably securable to one another using one or more of a zipper, hook and loop, one or more snaps, or one or more buttons, etc.

In some aspects, the cooling medium portion includes at least one channel that receives a fluid therein. In some aspects, the fluid can be a liquid, a gas, or a gel like composition. In some aspects, the at least one channel is fluidly connected with a pump, which directs the flow of the fluid within the at least one channel. In some aspects, when the cooling fluid comprises a gas, such as air, the at least one channel includes a plurality of perforations that allow the gas to pass from inside the channel to outside the channel. In some aspects, when the cooling fluid comprises a liquid, the at least one channel comprises a closed system, and the pump directs the cooling fluid from the pump, to the at least one channel, and from the at least one channel back to the pump.

In some aspects, the at least one channel is in fluid communication with a reservoir capable of receiving a cooling medium therein. In some aspects, the reservoir includes an inlet and/or an outlet for, for example, introducing a new cooling medium into the at least one channel, and/or removing a spent cooling medium from the at least one channel. In some aspects, the reservoir receives a solid, such as ice. In some aspects, one or more of the pump and the reservoir are secured to the waist belt portion of the fall prevention safety harness.

These and other aspects, features, and advantages of the present disclosure will be readily appreciable from the following description in view the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a front perspective view of a fall prevention safety harness including a personal cooling apparatus secured thereto;

FIG. 2 is a perspective view of a personal cooling apparatus for use in association with a fall prevention safety harness, shown as being detached from a fall prevention safety harness;

FIG. 3 is a cross-sectional view of a personal cooling apparatus used in association with a fall prevention safety harness, taken generally along line 3-3 of FIG. 2;

FIG. 4 is a front perspective view of a fall prevention safety harness including a personal cooling apparatus secured thereto; the personal cooling apparatus including a pump/reservoir that introduces a cooling medium into a channel of the personal cooling apparatus;

FIG. 5 is a perspective view of an air-cooled personal cooling apparatus;

FIG. 6 is a cross-sectional view of an air-cooled personal cooling apparatus, taken generally along line 6-6 of FIG. 5;

FIG. 7 is a perspective view of a fall prevention safety harness including a personal cooling apparatus secured thereto; the personal cooling apparatus including a pump/reservoir that introduces a cooling medium into a channel of the personal cooling apparatus;

FIG. 8 is a perspective view of a liquid-cooled, i.e., water, personal cooling apparatus; and,

FIG. 9 is a cross-sectional view of a liquid-cooled personal cooling apparatus, taken generally along line 9-9 of FIG. 8; and

FIGS. 10 and 11 are front and rear perspective view of a fall prevention safety harness including a personal cooling apparatus secured thereto.

### DETAILED DESCRIPTION

At the outset, it should be appreciated that like drawing numbers and/or the use of prime notations on different drawing views are intended to identify identical, similar, or functionally similar, structural elements. It is to be understood that the claims are not limited to the specifically disclosed and illustrated aspects.

Furthermore, it is understood that this disclosure is not limited to the particular methodologies, materials and modifications described and as such may, of course, vary. It is also understood that the terminology used herein is for the purpose of describing particular aspects only and is not intended to limit the scope of the disclosure or claims.

Unless defined otherwise, all technical and scientific terms used herein have the same meaning as commonly understood to one of ordinary skill in the art to which this disclosure belongs. Although any methods, devices or materials similar or equivalent to those described herein can be used in the practice the example aspects.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

It should be appreciated that the term “substantially” and “generally” are synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

By “non-rotatably connected” elements, it is meant that: the elements are connected so that whenever one of the elements rotate, all the elements rotate; and relative rotation between the elements is not possible. Radial and/or axial movement of non-rotatably connected elements with respect to each other is possible, but not required. Additionally, “plastic deformation” is intended to mean instances when a sufficient load is applied to a material that causes a permanent change in shape to that material.

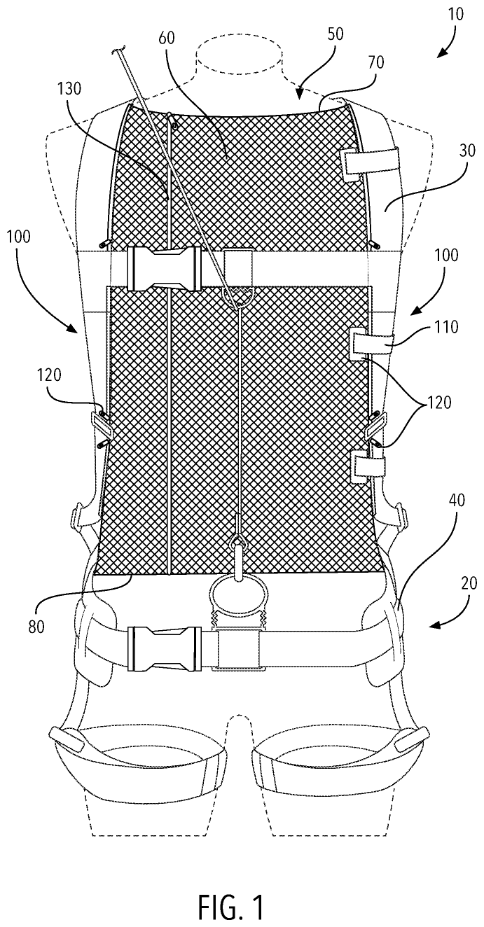

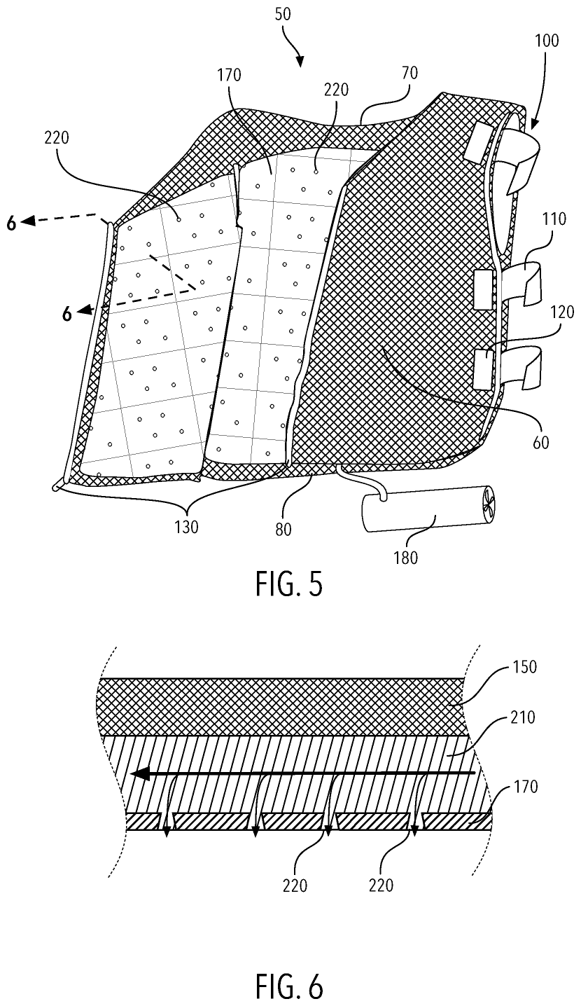

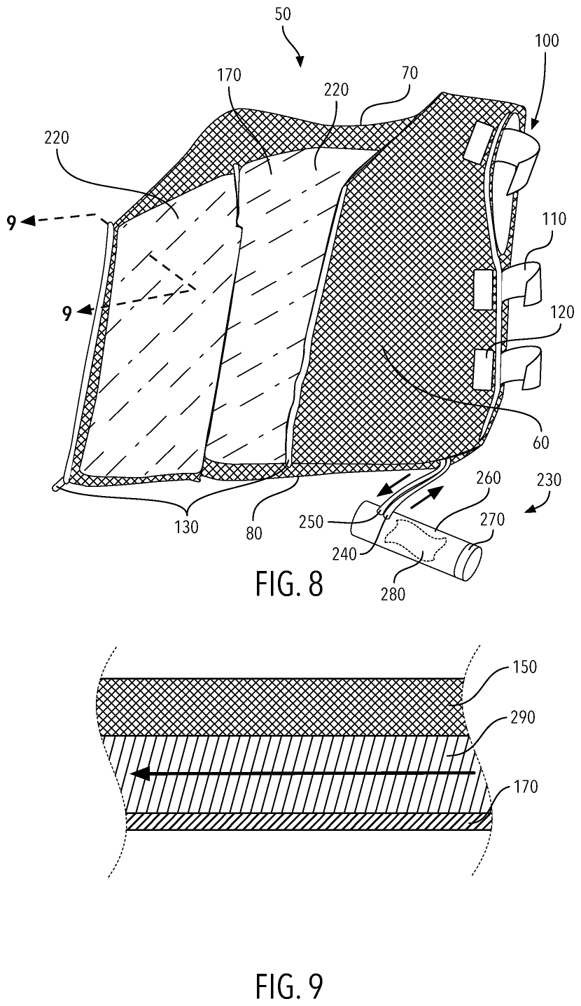

Adverting now to the figures, FIGS. 1-11 generally illustrate several aspects of a personal cooling apparatus and/or a cooling assembly for use in association with a fall prevention safety harness in accordance with the instant disclosure. As shown in FIG. 1, fall prevention safety harness cooling system 10 is shown generally as including fall prevention safety harness and personal cooling apparatus 50. Most fall prevention safety harnesses 20 generally include shoulder strap portions 30 and/or back strap portions 30 and are typically fabricated from nylon webbing and the like in accordance with various ANSI and/or OSHA requirements. Such safety harnesses also typically include waist belt portion 40, as well as leg strap portions that secure about the thigh region of a wearer.

With regard to the figures, it should be appreciated that if looking into the illustrated pages that the leftward and rightward sides of the various illustrated personal cooling apparatuses 50 appear to differ from one another, this is primarily for purposes of illustrating various potential aspects of personal cooling apparatus 50. That being said, as shown in FIGS. 1-11, personal cooling apparatus 50 is shown as generally including chest portion 60, collar portion 70, waist portion 80 and back portion 90. As may be appreciated chest portion 60 and back portion 90 are disposed between collar portion 70 and waist portion 80 and can extend therebetween. Chest portion 60 and back portion 70 can include strap receiving portions 100 for purposes of securing personal cooling apparatus 50 to fall prevention safety harness 20 either detachably, or fixedly.

In the case of detachably securing personal cooling apparatus 50 to fall prevention safety harness 20, FIGS. 1-11 shown that personal cooling apparatus 50 can include one or more of flaps/tabs 110 (shown on the rightward side of the figures if looking into the pages) including fasteners 120, or simply utilize fasteners 120, (as shown on both the leftward and rightward sides of the figures). In the case of utilizing fasteners 120 without flaps/tabs 110, the shoulder strap portions 30 and back strap portions 30 of fall prevention safety harness 20 can be modified to include one or more of releasable fasteners 120 such as a zipper, one or more buttons, one or more buckles, or hook and loop, etc. However, in view of the fact that any modification to shoulder strap portions 30 or back strap portions 30 of the fall prevention safety harness 20 may negatively affect the integrity of the fall prevention safety harness 20 itself, as shown on the rightward side of the figures, personal cooling apparatus 50 can be readily detachably secured to fall prevention safety harness 20 by utilizing flaps/tabs 110 that secure upon themselves utilizing fasteners 120, which can be one or more of a zipper, one or more buttons, one or more buckles, or hook and loop, etc. As may be appreciated from the figures, when flaps/tabs 110 are utilized, each flap/tab 110 can be wrapped or folded about a respective shoulder strap portion 30 or back strap portion 30 and secured to itself using fasteners 120 such that the integrity of the fall prevention safety harness is maintained. As also shown in the figures, in the case of either a fixed or detachably securable personal cooling apparatus 50, personal cooling apparatus 50 includes a fastener 130 disposed on chest portion 60 that allows the chest portion to be opened and closed for purposes of, for example, allowing a user to put on or remove the personal cooling apparatus. Fastener 130 for opening and closing chest portion 60 can be one or more of a zipper, one or more buttons, one or more buckles, or hook and loop, etc.

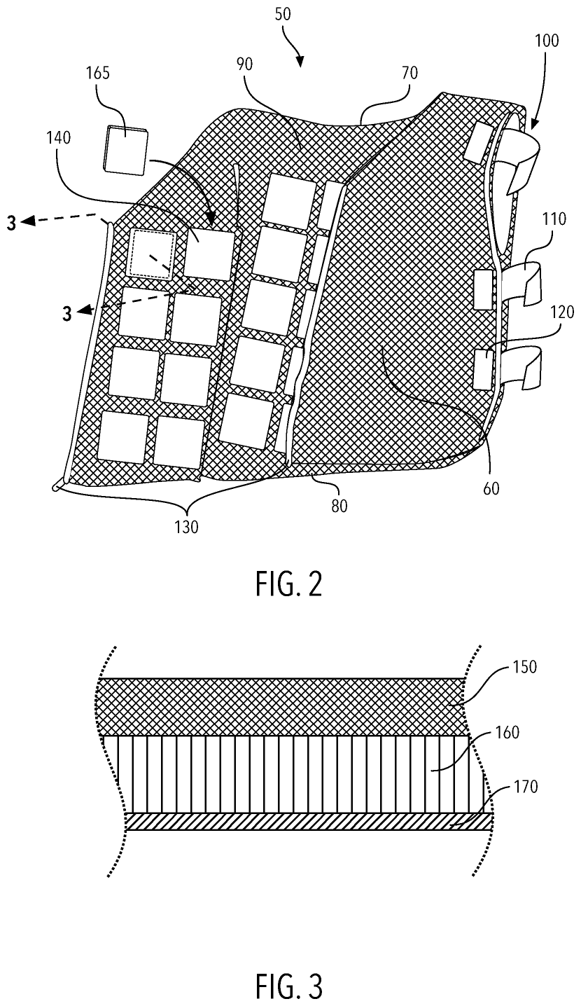

Turning now to FIGS. 2-11 which illustrate several different aspects of a personal cooling apparatus in accordance with the instant disclosure, as shown in FIGS. 2 and 3, in some aspects, personal cooling apparatus 50 can be configured to comprise one or more pockets/enclosures 140 disposed in the chest portion 60 and back portion 90 of personal cooling apparatus 50. As shown in FIG. 3, in some aspects personal cooling apparatus 50 generally includes outer layer 150, cooling medium 160, and inner layer 170. Outer layer 150 can be configured to comprise a rugged material or fabric that is resistant to tearing and/or puncturing and can also include an insulating/reflective material associated therewith so as to prevent warm, ambient air from prematurely warming the cooling medium 160. Inner layer 170 can comprise a suitable fabric and/or breathable fabric that allows the cooling effect of the cooling medium to be passed to a wearer. It should be appreciated that while FIG. 2 shows pockets/enclosures 140 as being disposed toward an interior of the personal cooling apparatus, access to pockets/enclosures 140 can be provided on an exterior of personal cooling apparatus 50 such that a user may insert or remove a suitable cooling medium 16 therefrom without having to first remove the personal cooling apparatus 50 from their person. Additionally, while it is not shown in the figures, pockets/enclosures 140 can be accessed via openings that are openable and closeable with appropriate fasteners, e.g., zippers, buttons, snaps, hook and loop, etc. As may be also appreciated, cooling medium 160 can comprise one or more self-contained type cooling media 165, for example, self-contained cooling media 165 can include one or more icepacks, gelpacks, chemical cooling packs, etc. that can be readily inserted and removed from the one or more pockets/enclosures 140.

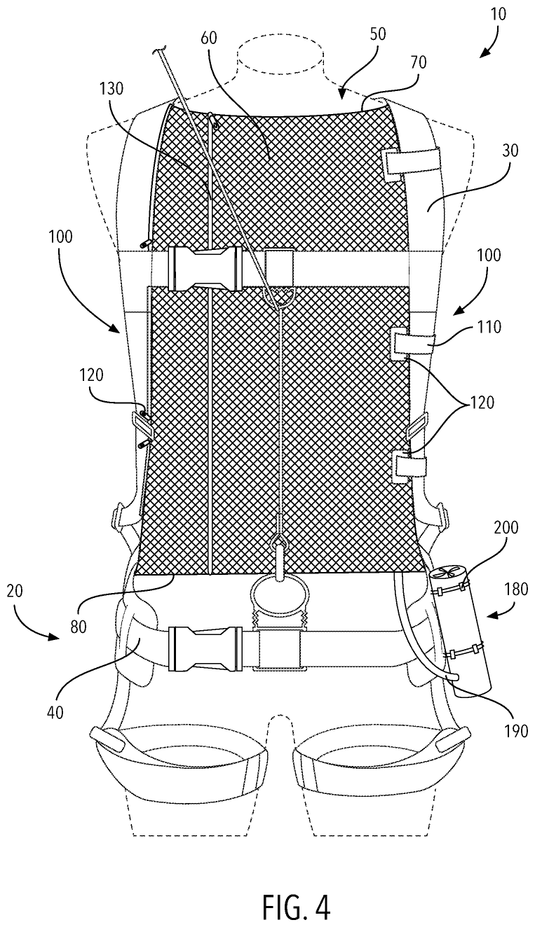

Turning now to FIGS. 4-6, which illustrate aspects of personal cooling apparatus 50 comprising a enclosure/channel 210 for receiving a cooling medium therein in the form of a fluid, e.g., air or gas. As may be apparent from the figures, personal cooling apparatus 50 of FIGS. 4-6 is somewhat similar to the personal cooling apparatus of FIGS. 1-3 in that it also includes, for example, chest portion 60, collar portion 70, waist portion 80 and back portion 90. Again, chest portion 60 and back portion 90 are disposed between collar portion 70 and waist portion 80 and can extend therebetween. Chest portion 60 and back portion 70 can include strap receiving portions 100 for purposes of securing personal cooling apparatus 50 to fall prevention safety harness 20 either detachably, or fixedly. Additionally, the personal cooling apparatus 50 illustrated in aspects in FIGS. 4-6 can include one or more of flaps/tabs 110 (shown on the rightward side of the figures if looking into the pages) including fasteners 120, or simply utilize fasteners 120, (as shown on both the leftward and rightward sides of the figures). In the case of utilizing fasteners 120 without flaps/tabs 110, the shoulder strap portions 30 and back strap portions 30 of fall prevention safety harness 20 can be modified to include one or more of releasable fasteners 120 such as a zipper, one or more buttons, one or more buckles, or hook and loop, etc. However, in view of the fact that any modification to shoulder strap portions or back strap portions 30 of the fall prevention safety harness 20 may negatively affect the integrity of the fall prevention safety harness 20 itself, as shown on the rightward side of the figures, personal cooling apparatus 50 can be readily detachably secured to fall prevention safety harness 20 by utilizing flaps/tabs 110 that secure upon themselves utilizing fasteners 120, which can be one or more of a zipper, one or more buttons, one or more buckles, or hook and loop, etc.

As may be appreciated from the figures, when flaps/tabs 110 are utilized, each flap/tab 110 can be wrapped or folded about a respective shoulder strap portion 30 or back strap portion 30 and secured to itself using fasteners 120 such that the integrity of the fall prevention safety harness is maintained. As also shown in the figures, in the case of either a fixed or detachably securable personal cooling apparatus 50, personal cooling apparatus 50 includes a fastener 130 disposed on chest portion 60 that allows the chest portion to be opened and closed for purposes of, for example, allowing a user to put on or remove the personal cooling apparatus. Fastener 130 for opening and closing chest portion 60 can be one or more of a zipper, one or more buttons, one or more buckles, or hook and loop, etc.

In aspects, however, personal cooling apparatus 50, as illustrated in FIGS. 4-6 can be configured to comprise one or more enclosures/channels 210 disposed in the chest portion 60 and back portion 90 of personal cooling apparatus 50. As shown in FIG. 6, in some aspects personal cooling apparatus 50 can include outer layer 150, enclosure/channel 210 that is capable of receiving a cooling medium 160 therein, inner layer 170, as well as cooling medium pump 180, which is in fluid communication with enclosure/channel 210, via conduit 190, for example.

Outer layer 150 can be configured to comprise a rugged material or fabric that is resistant to tearing and/or puncturing and can also include an insulating/reflective material associated therewith so as to prevent warm, ambient air from prematurely warming the cooling medium 160 within enclosure/channel 210. Inner layer 170 can comprise a suitable fabric and/or breathable fabric that allows the cooling effect of the cooling medium to be passed to a wearer, and can also include a plurality of apertures or perforations therein 220 for purposes of directing the cooling medium pumped into enclosure/channel 210 by pump 180 toward a wearer's body so as to provide a cooling effect (See, e.g., FIG. 6). Pump 180 can be in the form of an electric fan configured to pump ambient air into enclosure/channel 210. Pump 180 can further include an accessible reservoir for inserting/removing a self-contained cooling medium therein such that ambient air drawn in by the fan can be first passed over the self-contained cooling medium 165 and then into enclosure/channel 210. Pump 180 can be in the form of a battery powered fan and/or include means, such as a cord, receptacle, or inductive device, for recharging the pump power supply. Pump 180 can further include appropriate fasteners 200, such as strapping, snaps, buttons, hook and loop, or other suitable fasteners for securing pump 180 to waist belt portion 40 of fall prevention safety harness 20.

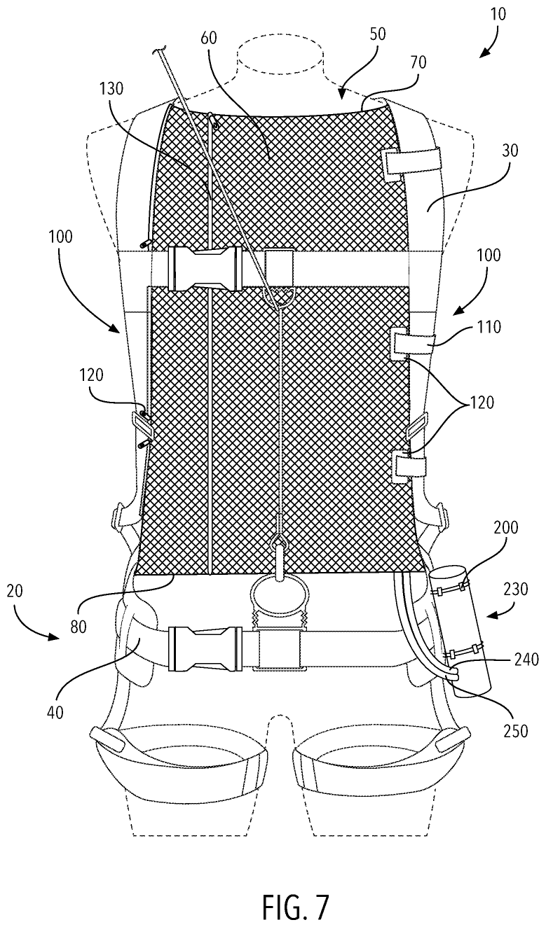

Turning now to FIGS. 7-9, which illustrate aspects of personal cooling apparatus 50 comprising an enclosure/channel 210 for receiving a cooling medium therein in the form of a fluid, e.g., a cooling liquid. As may be apparent from the figures, personal cooling apparatus 50 of FIGS. 7-9 is somewhat similar to the personal cooling apparatus of FIGS. 1-6 in that it also includes, for example, chest portion 60, collar portion 70, waist portion 80 and back portion 90. Again, chest portion 60 and back portion 90 are disposed between collar portion 70 and waist portion 80 and can extend therebetween. Chest portion 60 and back portion 70 can include strap receiving portions 100 for purposes of securing personal cooling apparatus 50 to fall prevention safety harness 20 either detachably, or fixedly. Additionally, the personal cooling apparatus 50 illustrated in aspects in FIGS. 7-9 can include one or more of flaps/tabs 110 (shown on the rightward side of the figures if looking into the pages) including fasteners 120, or simply utilize fasteners 120, (as shown on both the leftward and rightward sides of the figures). In the case of utilizing fasteners 120 without flaps/tabs 110, the shoulder strap portions and back strap portions 30 of fall prevention safety harness 20 can be modified to include one or more of releasable fasteners 120 such as a zipper, one or more buttons, one or more buckles, or hook and loop, etc. However, in view of the fact that any modification to shoulder strap portions 30 or back strap portions 30 of the fall prevention safety harness 20 may negatively affect the integrity of the fall prevention safety harness 20 itself, as shown on the rightward side of the figures, personal cooling apparatus 50 can be readily detachably secured to fall prevention safety harness 20 by utilizing flaps/tabs 110 that secure upon themselves utilizing fasteners 120, which can be one or more of a zipper, one or more buttons, one or more buckles, or hook and loop, etc. As may be appreciated from the figures, when flaps/tabs 110 are utilized, each flap/tab 110 can be wrapped or folded about a respective shoulder strap portion 30 or back strap portion and secured to itself using fasteners 120 such that the integrity of the fall prevention safety harness is maintained. As also shown in the figures, in the case of either a fixed or detachably securable personal cooling apparatus 50, personal cooling apparatus 50 includes a fastener 130 disposed on chest portion 60 that allows the chest portion to be opened and closed for purposes of, for example, allowing a user to put on or remove the personal cooling apparatus. Fastener 130 for opening and closing chest portion 60 can be one or more of a zipper, one or more buttons, one or more buckles, or hook and loop, etc.

In aspects, however, personal cooling apparatus 50, as illustrated in FIGS. 7-9 can be configured to comprise one or more enclosures/channels/tubes 290 disposed in the chest portion 60 and back portion 90 of personal cooling apparatus 50. As shown in FIG. 9, in some aspects personal cooling apparatus 50 can include outer layer 150, enclosures/channels/tubes 290 that are capable of receiving cooling medium 160 in the form of a liquid therein, inner layer 170, as well as cooling medium pump 230, which is in fluid communication with enclosures/channels/tubes 290 via conduits 240/250 that introduce and extract the cooling medium into and out of enclosures/channels/tubes 290 in a somewhat circuitous fashion, for example. Enclosures/channels/tubes 290 can be in the form of a liquid impermeable contiguous/continuous bladder formed of suitable polymers, for example, a plurality of liquid impermeable interstices or narrow channels capable of directing fluid flow to/from pump 230 via conduits 240/250, or liquid impermeable tubes capable of directing fluid flow to/from pump 230 via conduits 240/250. Such bladder/interstices/channels/tubes can be configured to direct the cooling fluid over wearer's body core so as to provide the most effective cooling to the wearer and then redirect spent cooling fluid back to the pump/reservoir 230, where it can then be recharged by passing the spent cooling fluid over cooling medium 280, e.g., ice, gelpacks, etc., disposed in reservoir 260. For example, freshly cooled fluid could be introduced into the enclosure/channels/interstices/tubes of personal cooling apparatus in a region proximate one or more of the shoulders/upper chest/upper back of a wearer and then be subsequently directed along a circuitous, or a winding channeled, path downward toward waist portion 80 and back to pump 230. Outer layer 150 can be configured to comprise a rugged material or fabric that is resistant to tearing and/or puncturing and can also include an insulating/reflective material associated therewith so as to prevent warm, ambient air from prematurely warming the cooling fluid within enclosure/channel/tubes. Inner layer 170 can comprise a suitable fabric and/or breathable fabric that allows the cooling effect of the cooling fluid to be passed to a wearer. Pump 230 can be in the form of an electric rotary pump configured to pump cooling liquid into enclosure/channel/tubes 290. Pump 230 can further include an accessible reservoir 260 for inserting/removing a cooling medium 280 therein such that cooling fluid pumped by pump 230 can be first passed over the cooling medium 280 and then along into enclosure/channel/tubes 290. Pump 230 can be in the form of a battery powered pump and/or include means, such as a cord, receptacle, or inductive device, for recharging the pump power supply. Pump 230 can further include appropriate fasteners 200, such as strapping, snaps, buttons, hook and loop, or other suitable fasteners for detachably securing pump 230 to waist belt portion 40 of fall prevention safety harness 20. Pump 230 can include one or more inlet or outlet caps 270 for introducing or discharging a cooling fluid, e.g., water, into/from enclosure/channels/tubes and/or adding removing a suitable cooling medium, such as ice, icepacks, or gel packs, therefrom. For example, in a case where a cooling fluid, e.g., water, and/or cooling medium, e.g., ice, has been spent after use, the spent water can be discharged and the enclosure/channels/tubes refilled with cooled water and/or the reservoir filled with a fresh cooling medium, e.g., ice, icepacks, or gelpacks, etc. Pump 230 can be detachably secured to conduits 240/250 and waist belt portion so as to allow easy storage/recharging/replacement/removal of the pump, if needed. In the case of removing the pump, conduits 240/250 can be fluidly connected to one another so as to allow the personal cooling apparatus 50 to be utilized without the pump, if desired. For example, pump 230 could be removed, conduits 240/250 fluidly connected to one another, and the personal cooling apparatus 50 placed in a cooled environment for later use.

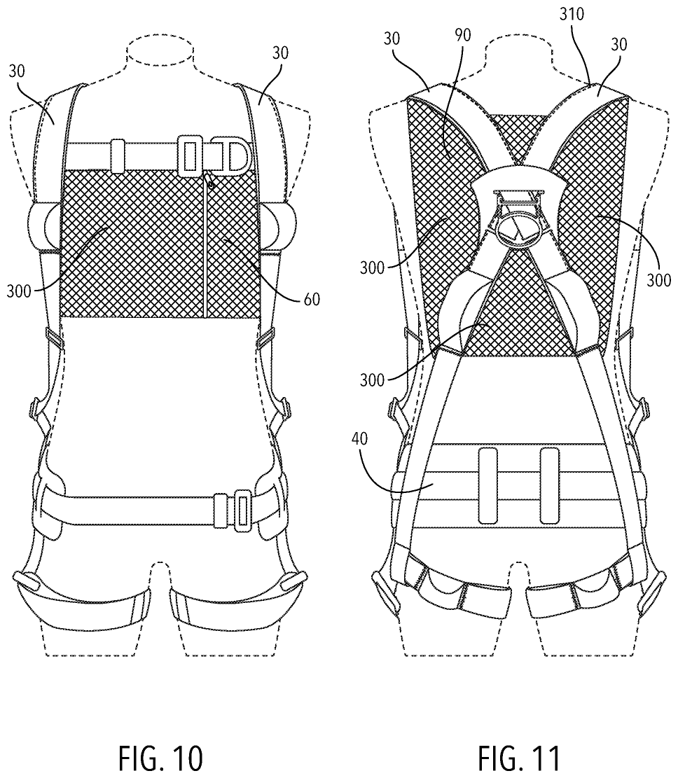

Referring now to FIGS. 10 and 11, which aspects of personal cooling apparatus 50 comprising a plurality of cooling panels 300. As may be apparent from the figures, personal cooling apparatus 50 can be configured to comprise one or more cooling panels 300 that can be fixed, or detachably secured, to fall prevention safety harness 20. In either case, the one or more cooling panels can include a chest portion 60 and back portion 90. In the case of a fixed arrangement, the chest portion 60 and back portion can be affixed to the safety harness with appropriate stitching for example, and include one or more pockets/enclosures 140 for receiving a self-contained cooling medium 165 therein in a manner similar to those aspects set forth relative to FIGS. 1-3. It should be understood, however, that in the case of a fixed arrangement, those portions of the personal cooling apparatus 50 corresponding to the shoulder/back strap portions 30 may not include an enclosure/channel 160 for receiving a cooling medium therein. With regard to a detachably secured arrangement, inner sides of shoulder/back strap portions 30, and those portions of panels 300 corresponding with shoulder/back strap portions 30, e.g., strap receiving portions 100, can be configured to include appropriate mating fasteners, such as buttons/snaps, hook and loop, etc. that allow the one or more panels 300 to be detachably secured to the fall prevention safety harness 20. In such case, the one or one panels 300 can be configured to comprise a cooling medium that was inaccessible to a user, or include one or more pockets/enclosures 140 that allow a cooling medium to be readily inserted/removed therefrom.

Finally, while the foregoing disclosure has generally described a personal cooling apparatus for use in association with a fall prevention safety harness for purposes of preventing or minimizing heat related injuries, the above-described apparatus could be modified for use in cold weather climates or environments for purposes of providing warmth to a wearer. In such cases, a heating element and/or a heated fluid, gels, or heat packs, etc., could be used in association with the apparatus.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### PARTS LIST

10 Fall Prevention Safety Harness Cooling System
20 Fall Prevention Safety Harness
30 Shoulder/Back Strap Portion
40 Waist Belt Portion
50 Personal Cooling Apparatus
60 Chest Portion
70 Collar Portion
80 Waist Portion
90 Back Portion
100 Strap Receiving Portion
110 Flap/Tab
120 Fastener
130 Chest Portion Fastener
140 Pocket/Enclosure
150 Outer Layer
160 Cooling medium
165 Insertable Cooling Medium/Gelpack
170 Inner Layer
180 Pump (Fan)
190 Conduit
200 Fastener
210 Enclosure/Channel
220 Perforations
230 Pump
240 Conduit (Input/Output)
250 Conduit (Input/Output)
260 Reservoir
270 Removable Cap
280 Solid Cooling Medium, e.g., Ice
290 Enclosure/Channel/Tube
300 Panel
310 Fastening Means (Stitching or Detachable Means)

What is claimed is:

1. A personal cooling apparatus wearable by an individual and configured for use in association with a fall prevention safety harness including at least a shoulder strap portion, a back strap portion, and a waist belt portion, the personal cooling apparatus comprising:
a chest portion; and
a back portion,
wherein, each of the chest portion and the back portion include a cooling portion and a strap receiving portion;
wherein the cooling portion includes an inner layer, an outer layer, and a cooling medium disposed between the inner layer and the outer layer;
wherein the strap receiving portion of the personal cooling apparatus is securable to at least one of the shoulder strap portion and the back strap portion of the fall prevention safety harness.

2. The personal cooling apparatus of claim 1, wherein the strap receiving portion does not include a cooling medium.

3. The personal cooling apparatus of claim 1, wherein the strap receiving portion is detachably securable to at least one of the shoulder strap portion and the back strap portion.

4. The personal cooling apparatus of claim 3, wherein the strap receiving portion is detachably securable to at least one of the shoulder strap portion and the back strap portion using one or more of hook and loop, one or more snaps, or one or more buttons.

5. The personal cooling apparatus of claim 1, wherein the chest portion and the back portion include at least one pocket that receives the cooling medium therein.

6. The personal cooling apparatus of claim 5, wherein the at least one pocket is openable and closable using one or more of a zipper, hook and loop, one or more snaps, or one or more buttons.

7. The personal cooling apparatus of claim 1, wherein the chest portion extends from a collar portion to a waist portion, the chest portion having rightward and leftward sides that are detachably securable to one another using one or more of a zipper, hook and loop, one or more snaps, or one or more buttons.

8. The personal cooling apparatus of claim 1, wherein the strap receiving portion is fixedly secured to at least one of the shoulder strap portion and the back strap portion.

9. The personal cooling apparatus of claim 8, wherein the strap receiving portion is fixedly secured to at least one of the shoulder strap portion and the back strap portion by stitching.

10. The personal cooling apparatus of claim 6, wherein the at least one pocket of the back portion includes an opening formed in the outer layer.

11. The personal cooling apparatus of claim 10, wherein the opening is openable and closable using one or more of a zipper, hook and loop, one or more snaps, or one or more buttons.

12. The personal cooling apparatus of claim 6, wherein the at least one pocket of the chest portion includes an opening formed in the outer layer.

13. The personal cooling apparatus of claim 12, wherein the opening is opening and closable using one or more of a zipper, hook and loop, one or more snaps, or one or more buttons.

14. The personal cooling apparatus of claim 3, wherein the detachably securable strap receiving portion includes a folding flap portion that is configured to be wrapped about a portion of at least one of the shoulder strap portion and the back strap portion.

15. The personal cooling apparatus of claim 14, wherein the folding flap portion is configured to fold upon the at least one of the shoulder strap portion and the back strap portion and detachably secure to the detachably securable receiving portion by one or more of hook and loop, one or more snaps, or one or more buttons.

16. The personal cooling apparatus of claim 1, wherein the cooling portion comprises at least one channel that receives a cooling medium therein, the cooling medium comprising a cooling fluid in the form of a liquid or a gas.

17. The personal cooling apparatus of claim 16, wherein the at least one channel is fluidly connected with a pump, the pump directing flow of the cooling fluid within the at least one channel.

18. The personal cooling apparatus of claim 17, wherein when the cooling fluid comprises a gas, the at least one channel includes a plurality of perforations allowing the gas to pass from inside the channel to outside the channel.

19. The personal cooling apparatus of claim 17, wherein when the cooling fluid comprises a liquid, the at least one channel comprises a closed system, and the pump directs the cooling fluid from the pump, to the at least one channel, and from the at least one channel to the pump.

20. The personal cooling apparatus of claim 17, wherein the pump is secured to the waist belt portion of the fall prevention safety harness.

21. The personal cooling apparatus of claim 20, wherein the at least one channel is in fluid communication with a reservoir, the pump introducing and removing the cooling medium to/from the reservoir and the at least one channel.

22. The personal cooling apparatus of claim 21, wherein the reservoir is configured to receive a solid therein.

23. The personal cooling apparatus of claim 22, wherein the reservoir is secured to the waist belt portion of the fall prevention safety harness.
